(19) United States
(12) Patent Application Publication
(10) Pub. No.: US 2022/0053752 A1
(43) Pub. Date: Feb. 24, 2022

(54) CONTROL OF PLANTS

(71) Applicant: Bayer Aktiengesellschaft, Leverkusen (DE)

(72) Inventor: Michael KILIAN, Leverkusen (DE)

(73) Assignee: Bayer Aktiengesellschaft, Leverkusen (DE)

(21) Appl. No.: 17/309,765

(22) PCT Filed: Dec. 13, 2019
(86) PCT No.: PCT/EP2019/085057

§ 371 Date: Jun. 17, 2021

(30) Foreign Application Priority Data
Dec. 19, 2018 (EP) 18213830.5

(51) Int. Cl. A01M 21/04; A01M 21/02; A01D 43/063

(52) U.S. Cl. CPC A01M 21/046; A01D 43/063; A01M 21/02

(57) ABSTRACT

The disclosure relates to the control of plants by means of electrical energy and the mechanical removal of parts of the plants. The disclosure relates to a method and a device for the control of undesired plants by electrical and mechanical means.

### CROSS REFERENCE TO RELATED APPLICATIONS

This application is a national stage application under 35 U.S.C. § 371 of International Application No. PCT/EP2019/085057, filed internationally on Dec. 13, 2019, which claims benefit of European Application No. 18213830.5, filed Dec. 19, 2018.

### FIELD OF THE DISCLOSURE

The present disclosure relates to the control of plants by means of electrical energy and the subsequent mechanical removal of plant parts. Subject matter of the present disclosure is a method and a device for the control of undesired plants by electrical and mechanical means.

### BACKGROUND OF THE DISCLOSURE

There are a large number of situations in which plants or plant parts must be removed. Controlling plants on railroad tracks, for example, is essential for safety reasons. The ballast bed, in particular, must be cleared of plant growth and/or kept clear. The ballast bed is usually flexible, and helps to transfer both static and dynamic loads evenly to the sub-ballast. The innumerable spaces between the individual stones cushion the enormous weight of passing trains and the impacts like a buffer.

When crop plants are cultivated in a field, undesired accompanying plants that compete with the crop plants for resources, prevent the performance of agricultural measures or make them more difficult, impair the quality of the yield or have a negative effect on the cultivation of the crop plants in other ways, usually appear.

### SUMMARY OF THE DISCLOSURE

To improve the quality and quantity of crop yields, undesired accompanying plants should be controlled early. Plants can sprout in the joints of sidewalks, roadsides, gutters, parking areas, squares and the like. The roots can lead to damage to the structures. In addition, paving stones that are pushed upwards by roots present a safety risk due to the danger of tripping. Control of the plants is appropriate again here.

A range of measures are available for the control of plants such as, for example, the application of a herbicide, mechanical removal, or control by electrical energy.

There can be areas in which an application of herbicides is unwanted or—for example because of resistances—does not bring the desired success.

Mechanical removal is comparatively tedious and/or expensive, since usually the plant has to be removed together with its root system in order to prevent it sprouting again.

In the control of unwanted plants using electrical energy, the plant concerned is brought into contact with a first electrode (also referred to in this description as the contact electrode). A second electrode (also referred to as the collecting electrode in this description) is usually in contact with the ground in which the plant is growing. A voltage is applied between the electrodes. If the plant comes into contact with the first electrode, an electrical current flows from the first electrode through at least part of the plant and the ground to the second electrode. The roots are here also affected by the electrical current. This electric shock leads to weakening or killing of the plant.

When plants are controlled with electrical energy, the destroyed plants usually remain in or on the ground where they gradually decay or are removed by erosion. Plants or plant residues remaining in or on the ground are, however, often unwanted not only for esthetic reasons. In a field in which crop plants are cultivated, the decaying plant parts can be a source for infestation with pests such as, for example, fungi. People can slip on the plants or plant residues on sidewalks or squares. The remaining organic material can, furthermore, encourage the sprouting of further plants, acting, for example, as a seedbed.

There is therefore a need for a solution for the control and removal of unwanted plants that on the one hand prevents the plants from sprouting again and on the other hand removes residues of dead plants.

According to some embodiments, a first subject matter of the invention is a device comprising
a collecting electrode, wherein the collecting electrode is implemented in such a way that it can be brought into contact with the ground,
a contact electrode, wherein the contact electrode is implemented in such a way that it can be brought to a defined height above the ground, wherein the contact electrode is attached to the device in a frontal region of the device,
a voltage source for the application of a voltage between the contact electrode and the collecting electrode and
a removal tool that is located behind the contact electrode,
   wherein the device is implemented in such a way that it can be moved over the ground, and when it moves in such a way the contact electrode comes into contact with plants that are growing in the ground, wherein when such contact occurs an electrical current flows between the contact electrode and the collecting electrode through parts of the plants, and the parts of the plants that are located above the ground are removed by the removal tool after the flow of current.

According to some embodiments, a further subject matter of the present invention is a method comprising the steps of
providing a device comprising
   a collecting electrode, wherein the collecting electrode is implemented in such a way that it is in contact with a ground,
   a contact electrode, wherein the contact electrode is implemented in such a way that it is located at a defined height above the ground,
   a voltage source with which a voltage is applied between the contact electrode and the collecting electrode, and
   a removal tool,
moving the device over the ground in the direction of an unwanted plant, wherein the contact electrode is located, in the sense of the movement direction, in front of the removal tool, and thereby:
   bringing the unwanted plant in the ground into contact with the contact electrode, wherein an electrical current flows between the contact electrode and the collecting electrode through the plant,
   following the flow of current: removing parts of the plant that are located above the ground with the removal tool.

The invention is explained in more detail below without distinguishing between the subject matter of the invention (device, method). The following explanations should rather apply to all subject matter of the invention in an analogous manner, regardless of the context (device, method) in which they occur.

If steps are referred to in a sequence in the present description or in the patent claims, this does not necessarily mean that the invention is restricted to the sequence mentioned. Rather it is conceivable that the steps can also be carried out in a different sequence or, also, in parallel with one another, unless one step builds on another step that makes it essential that the building step is carried out afterwards (which, however, will be clear in the individual case). The sequences referred to thus represent preferred embodiments of the invention.

According to some embodiments, the present invention serves for the control of unwanted plants. Unwanted plants can be, for example, broadleaved weeds/grass weeds in a field of crop plants, plants in ballast beds of railroad tracks, plants on sidewalks or roadways or at roadsides, plants on uncultivated land such as, for example, industrial premises or the like.

The term “control” refers to a prevention of the propagation, or a reduction in the quantity, of unwanted plants that are present.

The control takes place in a first step by means of electrical energy that is introduced into the plant. The introduction of the energy takes place with the aid of at least two electrodes, between which an electrical voltage is present: with at least one contact electrode and at least one collecting electrode. The aim is to weaken or destroy the unwanted plant in that an electrical current flows between the at least two electrodes, flowing at least through one part of the plant and thereby affecting roots of the plant in order to prevent further sprouting.

The contact electrode can be implemented as a cantilever arm, net, grille, strip, brush, lance or the like. Multiple contact electrodes can also be present.

The collecting electrode can be implemented as a cantilever arm, net, grille, strip, brush, wheel, plough, lance or the like. Multiple collecting electrodes can also be present.

The voltage between the at least two electrodes is generated by a voltage source. The voltage source can, for example, be a generator or an accumulator. According to some embodiments, it is also conceivable that the device according to the invention has a plurality of voltage sources.

The voltage between the contact electrode and the collecting electrode can be a direct voltage or an alternating voltage. Preferably it is an alternating voltage. It can be a sinusoidal alternating voltage, a sawtooth voltage, a rectangular voltage or another form.

Details of the design of the electrodes and the voltage source can be found in the prior art (see, for example, U.S. Pat. Nos. 2,484,443A, 2,591,597A, 2,682,729A, 4,047,326A, 4,428,150A, WO2016016627A1, WO201662667A1, WO2018050137A1, WO2018050138A1, WO2018050142A1, WO2018050143A2).

To control a plant with electrical energy the plant is brought into contact with the contact electrode. Usually the contact electrode is moved horizontally above a ground in which the unwanted plant is present (or a plurality of unwanted plants are present).

The term “ground” refers to a region of the Earth's surface in which plants grow. Preferably the ground is the earth, while railroad tracks, roads, sidewalks, squares and other regions where plants can occur should also be included under the term “ground”.

When controlling the plant, the contact electrode is usually located at a defined height above the ground in which the plant is growing. The height above the ground is usually selected in such a way that the contact electrode comes into contact with an upper part of the unwanted plant in the course of a horizontal movement over the ground. The upper part can be the upper half or the upper third or another fraction of the plant. It is also conceivable that the contact electrode touches a central part or a lower part of the plant. It is also conceivable that the contact electrode touches the ground (in which case the defined height above the ground is equal to zero).

Preferably the contact electrode is designed to have an adjustable height. Preferably a distance sensor is present, or a plurality of distance sensors are present, with which the distance of the contact electrode from the ground can be ascertained.

The term “distance of the contact electrode from the ground” refers preferably to the vertical distance of the contact electrode from the ground. Preferably it is the shortest distance between the ground and an outer end of the contact electrode that is located nearest to the ground. If a plumb line is dropped from the outer end of the contact electrode, which is closest to the ground, to the ground, the “distance of the contact electrode from the ground” preferably corresponds to the length of this line.

A control unit is preferably present with which a defined distance between the contact electrode and the ground can be automatically adjusted and/or automatically maintained. The defined distance can be a minimum distance from the ground; it can also be a maximum distance from the ground.

Distance sensors are commercially available in a variety of forms, and are based on different measuring principles such as radar (W. Paul, H. Speckmann: Radarsensoren—Neue Technologien zur präzisen Bestandsführung, Landtechnik 59, 2/2004, pp. 92 to 93.), laser light (https://www.researchgate.net/publication/265943938) or ultrasound (D. Nieberg et al.: Multireflex-Ultraschall-Sensorsystem zur Feld-Phänotypisierung von Getreide, https://www.hs-osnabrueck.de/fileadmin/HSOS/Homepages/COALA/Veroeffentlichungen/2014-VDI-Tagung-Multireflex-Ultraschall-Sensorsystem_zur_Feld-Phaenotypisierung_von_Getreide_pdf).

The defined distance can further be oriented to the growth height of the plants to be controlled. Preferably at least one plant sensor is present with which the growth height of the plants to be controlled can be ascertained. According to some embodiments, the aim can be to bring the contact electrode into contact with a plant as the device according to the invention moves in the region of the upper third or in the region of the upper half of the plant, or into contact with another fraction of the plant. According to some embodiments, it is, for example, conceivable that the device according to the invention has one or a plurality of cameras with which the height at which the plants end (growth height) is ascertained. A growth height of plants can also be ascertained with one or a plurality of distance sensors: if the horizontal distance between a distance sensor and a plant is measured, and the height of the distance sensor is moved horizontally in this case, the horizontal distance on reaching the upper end of the plant rises suddenly (towards infinity, if there are no other objects located behind the plant); the height of the distance sensor above the ground during the sudden rise in the horizontal distance of the plant corresponds to the growth height of the plant.

The collecting electrode is usually attached in such a way that it touches the ground. It is therefore preferably designed as a sliding contact, a plough or a wheel that continuously touches the ground as the device moves. It is, however, also conceivable that the collecting electrode only touches the ground temporarily, for example when the contact electrode is in contact with an unwanted plant.

According to some embodiments, the device according to the invention can have one or a plurality of contact sensors that acquire whether the contact electrode is in contact with a plant. When there is such a contact, the collecting electrode can be brought into contact with the ground. Such a contact sensor can, for example, be a microswitch, a strain gauge or a piezoelectric sensor. The use of a photodiode on which less (day)light falls when in contact with a plant, is also conceivable.

It is also conceivable that a voltage is only then applied between the contact electrode and the collecting electrode when the contact electrode comes into contact with a plant. It is furthermore conceivable that a plurality of contact electrodes are present, being, for example, arranged next to one another (wherein such an arrangement preferably extends perpendicularly to the movement direction and horizontally with respect to the ground), wherein only those contact electrodes that have contact with a plant are subjected to voltage.

The collecting electrode is usually located at a constant distance from the contact electrode; it is, however, also conceivable that the distance from the contact electrode can be varied.

The term “distance between the collecting electrode and the contact electrode” preferably refers to the horizontal distance. Preferably it is the shortest distance between the collecting electrode and the contact electrode, wherein the distance between those regions of the collecting electrode and the contact electrode that are closest to one another is ascertained.

The distance between the collecting electrode and the contact electrode is a parameter that has an effect on the penetration depth of the electrical current into the ground. Expressed simply, the greater is the distance between the collecting electrode and the contact electrode, the greater is the penetration depth. The greater is the penetration depth, the deeper are the roots of the plant that are affected by the flow of current. On the other hand, the electrical resistance between the contact electrode and the collecting electrode, and thereby the amount of energy to be applied, increase with increasing distance. Optimum distances for an effective control of the plants with a minimum use of energy can be ascertained through empirical test series for various plant types, plant sizes, ground types and ground humidities.

After the first step of controlling an unwanted plant with electrical energy, the removal of parts of the controlled plant takes place in a second step. The first and the second step can also proceed in parallel. The control is usually limited to parts of the plant above the ground. Usually it is the parts of a plant above the ground that can cause a problem. The roots are destroyed by the control with electrical energy, so that renewed sprouting of the plant is prevented. The roots can therefore remain in the ground, and it is only the parts of the plant above the ground that are removed.

Since it is not necessary to remove the complete plant including its root system, the effort for mechanical control in the second step is comparatively small when compared to complete removal. The combination of electrical control and mechanical removal of the plant parts above the ground is thus a more effective, faster and more economical method when compared with the individual measures or with the mechanical removal of the plant with all its root system.

The removal of the plant parts above the ground is performed with a removal tool. The plant parts above the ground can, for example, be cut off, snapped off, bent or separated from the root system in another manner. The removal tool can accordingly be implemented as a cutting tool, sawing tool, abrasion tool, tearing tool and/or the like. The removal tool can be implemented as described in the prior art (see e.g. DE4135414A1, DE20309769U1, GB2461536A, US2015201607A, U.S. Pat. No. 5,842,331A, DE19840424A1, DE10055473A1). A combination of different tools, or the use of a plurality of removal tools, is also conceivable.

In one preferred embodiment the removal tool is implemented as a rotating wire brush, as is described by way of example in U.S. Pat. No. 5,842,331A, WO2018/226768, DE102017110776A1, DE102012002894A1 or in US2015201607A. The rotating brush can complete a rotary movement about an axis that is horizontal, i.e. that extends parallel to the ground. A rotating brush that completes a rotary movement about an axis that extends vertically (perpendicular to the ground) is also conceivable. It is also conceivable that a pair of vertically rotating brushes with opposing directions of rotation is present. It is conceivable that a plurality of brushes or pairs of brushes are present.

In an alternative embodiment, the removal tool is implemented as a cutting tool. The cutting tool can be implemented in the form of one or a plurality of horizontally or vertically rotating blades (see e.g. CN108738675A, US2018338426A, US2018184587A). The cutting tool can also be implemented as a blade or arrangement of blades that are arranged horizontally and that extend forward in the sense of the movement direction (see e.g. CN108907914A, CN108575271A, CN108012656A, US2018168101A, US2017049051A).

According to some embodiments, the removal tool can be arranged, in the sense of the movement direction of the device according to the invention, behind the contact electrode, so that a movement of the device in the direction of an unwanted plant brings the unwanted plant into contact with the contact electrode in a first step, and the unwanted plant comes into contact with the removal tool in a second step. The contact with the contact electrode leads to a weakening or destruction of the plant, by which the root system is also affected. The removal tool separates plant parts above the ground from plant parts in the ground.

It is conceivable that the removal tool functions simultaneously as the contact electrode, so that the control using electrical energy and the mechanical removal of plant parts take place simultaneously in one step. It is, for example, conceivable that a rotating wire brush is used both as the contact electrode and as the removal tool. An electrical voltage is applied between the rotating wire brush and one or a plurality of collecting electrodes. If the plant comes into contact with the rotating wire brush, a current flows through the plant via the brush ends. At the same time the plant can be clamped between the brush ends or can be impaled by the brush ends and torn or pulled out of the ground by the rotary movement.

The removal tool that is functioning as the contact electrode can also be implemented as a blade. An electrical voltage is applied between the blade and one or a plurality of collecting electrodes. On contact of the blade with a plant an electrical current flows through the plant via the blade. The plant is cut through by the blade at the same time.

Further possibilities for the combination of the removal tool and contact electrode are conceivable.

It is further possible that the removal tool functions simultaneously as a collecting electrode. The collecting electrode/removal tool can, for example, be implemented as a rotating wire brush that is in contact with the ground. The contact electrode can be located, in the sense of the movement direction, in front of the rotating wire brush. An electrical voltage is present between the contact electrode and the rotating wire brush. According to some embodiments, as the device according to the invention approaches a plant, the plant first comes into contact with the contact electrode. An electrical current flows between the wire brush and the contact electrode, passing through parts of the plant. As the device moves further in the movement direction, the plant is captured by the rotating wire brush and torn apart.

In one preferred embodiment the height of the removal tool is adjustable. Preferably at least one distance sensor is present with which the distance of the removal tool from the ground can be ascertained.

The term “distance of the removal tool from the ground” refers preferably to the vertical distance. Preferably it is the shortest distance between the ground and an outer end of the removal tool that is located nearest to the ground. If a plumb line is dropped from the outer end of the removal tool, which is closest to the ground, to the ground, the “distance of the removal tool from the ground” preferably corresponds to the length of this line.

A control unit is preferably present with which a defined distance between the removal tool and the ground can be automatically adjusted and/or automatically maintained. The defined distance can be a minimum distance from the ground; it can also be a maximum distance from the ground.

In one preferred embodiment, a collecting container for the separated plant parts is located, in the sense of the movement direction of the device according to the invention, behind the removal tool. In one preferred embodiment, the plant parts are automatically separated and automatically conveyed into the collecting container.

It is conceivable that the plant parts are separated in a first step, falling to the ground at the time; in a second step, they can be picked up by a sweeping tool and conveyed into a collecting container. It is also, however, conceivable that the plant parts are separated by a removal tool and are immediately conveyed into a collecting container by the removal tool or by a further tool such as, for example, a fan or a suction apparatus.

According to some embodiments, the device according to the invention can be implemented as a vehicle, or can be implemented to be connectable to a vehicle. Such a vehicle can be an agricultural machine (e.g. a tractor), a road vehicle (e.g. a Unimog), a rail vehicle or the like. According to some embodiments, the device according to the invention can furthermore be implemented as a manned or unmanned aircraft (drone). According to some embodiments, the device according to the invention can furthermore be implemented as a robot that moves autonomously over the ground in which unwanted plants are growing.

According to some embodiments, the device according to the invention can be implemented in such a way that it moves autonomously, or under the control of a person, over a field, a vineyard, a square, along a road, over a railroad track, along rails or the like and controls unwanted plants.

According to some embodiments, the device according to the invention can be fitted with means for recognizing unwanted plants. According to some embodiments, one or a plurality of cameras that generate digital images of the surroundings of the device according to the invention can, for example, be present. The digital images can be analyzed for whether unwanted plants are present. According to some embodiments, in the event that unwanted plants are present, parameters of the device according to the invention can be adjusted appropriately for the identified plants, such as for example: application of a voltage between at least one (defined) contact electrode and at least one (defined) collecting electrode, level of the voltage, in the case of alternating voltage frequency of the alternating voltage and/or waveform of the alternating voltage, distance of the contact electrode from the ground, distance of the removal tool from the ground, speed of movement of the device over the ground and the like. According to some embodiments, these adjustments can be carried out by one or a plurality of control units of the device according to the invention. The means for the recognition of unwanted plants can be configured in such a way that they recognize plants or even recognize individual plant species. Such means are described in the prior art (see e.g. WO2018141995A1, WO2018154490A1).

According to some embodiments, it is conceivable that the device according to the invention is a transportable device that can be attached to a vehicle or aircraft. According to some embodiments, it is further conceivable that the device consists of a plurality of components (elements) that are attached individually to a vehicle or aircraft in order to execute the invention. Individual elements can be: a voltage source or a plurality of voltage sources, a contact electrode or a plurality of contact electrodes (e.g. an arrangement of contact electrodes), a collecting electrode or a plurality of collecting electrodes (e.g. an arrangement of collecting electrodes), a removal tool or a plurality of removal tools (e.g. an arrangement of removal tools), a collecting container or a plurality of collecting containers (e.g. an arrangement of collecting containers), a sensor or a plurality of sensors and a control unit or a plurality of control units.

Further exemplary embodiments of the present invention are:

Embodiment 1. A Device Comprising
a collecting electrode, wherein the collecting electrode is implemented in such a way that it is in contact with a ground or can be brought into contact with the ground,
a contact electrode, wherein the contact electrode is implemented in such a way that it is located at a defined height above the ground or can be brought to a defined height above the ground,
a voltage source for the application of a voltage between the contact electrode and the collecting electrode, and
a removal tool,
wherein the device is implemented in such a way that it can be moved over the ground in the direction of an unwanted plant, wherein
   the plant comes into contact with the contact electrode due to the movement,
   is weakened or destroyed by an electrical current between the contact electrode and the collecting electrode, and
   parts of the weakened or destroyed plants located above the ground are removed by the removal tool;

Embodiment 2. The device according to embodiment 1, wherein the removal tool functions simultaneously as a contact electrode.

Embodiment 3. The device according to embodiment 1, wherein
the contact electrode is attached to the device in a front region that is located at the front when the device moves in a movement direction,
the removal tool is attached to the device in a rear region that is located behind the contact electrode when the device moves in the movement direction.

Embodiment 4. The device according to one of embodiments 1 to 3, wherein the removal tool and/or the contact electrode is/are implemented as a rotating wire brush.

Embodiment 5. The device according to one of embodiments 1 to 4, wherein the removal tool and/or the contact electrode is/are implemented as a blade or an arrangement of blades.

Embodiment 6. The device according to one of embodiments 1 to 5, wherein the collecting electrode is implemented as a sliding contact, plough or wheel.

Embodiment 7. The device according to one of embodiments 1, 3, 4 or 5, wherein the removal tool acts simultaneously as a collecting electrode.

Embodiment 8. The device according to one of embodiments 1 to 7, wherein the collecting electrode and/or the removal tool is/are implemented as a rotating wire brush.

Embodiment 9. The device according to one of embodiments 1 to 8, comprising one or a plurality of distance sensors for ascertaining the distance
of the contact electrode from the ground,
of the removal tool from the ground,
of the collecting electrode from the ground, and/or
of the contact electrode from the collecting electrode.

Embodiment 10. The device according to one of embodiments 1 to 9, comprising one or a plurality of plant sensors for ascertaining the growth height of the plants and/or one or a plurality of contact sensors for ascertaining a contact of the contact electrode with a plant.

Embodiment 11. The device according to one of embodiments 1 to 10, comprising a control unit that is configured to adjust the distance between the contact electrode and the ground, the distance between the removal tool and the ground and/or the distance between the collecting electrode and the contact electrode to a defined value and/or to hold them at a defined value.

Embodiment 12. The device according to one of embodiments 1 to 11, comprising a collecting container for receiving separated plant parts.

Embodiment 13. A method comprising the steps of
providing a device comprising
   a collecting electrode, wherein the collecting electrode is implemented in such a way that it is in contact with a ground,
   a contact electrode, wherein the contact electrode is implemented in such a way that it is located at a defined height above the ground,
   a voltage source with which a voltage is applied between the contact electrode and the collecting electrode, and
   a removal tool,
moving the device over the ground in the direction of an unwanted plant, and thereby:
   bringing the unwanted plant in the ground into contact with the contact electrode, wherein an electrical current flows between the contact electrode and the collecting electrode through the plant, whereby the electrical current weakens or destroys the plant,
   removing parts of the weakened or destroyed plant above the ground with the removal tool.

Embodiment 14. The method according to embodiment 13, comprising the steps of
providing a device comprising
   a collecting electrode, wherein the collecting electrode is implemented in such a way that it is in contact with a ground,
   a contact electrode, wherein the contact electrode is implemented in such a way that it is located at a defined height above the ground, and wherein the contact electrode is attached to the device in a frontal region that is located at the front when the device moves in a movement direction,
   a voltage source with which a voltage is applied between the contact electrode and the collecting electrode, and
   a removal tool, wherein the removal tool is attached to the device in a rear region that is located behind the contact electrode when the device moves in the movement direction,
moving the device in the movement direction and thereby:
   bringing an unwanted plant in the ground into contact with the contact electrode, wherein an electrical current flows between the contact electrode and the collecting electrode through the plant, wherein the electrical current weakens or destroys the plant,
   subsequently removing parts of the weakened or destroyed plant above the ground with the removal tool.

Embodiment 15. The method according to embodiment 13, wherein the removal tool functions simultaneously as the contact electrode, or the removal tool functions simultaneously as the collecting electrode.

### BRIEF DESCRIPTION OF THE DRAWINGS

The invention is described in more detail below with reference to figures, by way of example only, without wishing to restrict the invention to the features and feature combinations illustrated in the figures.

FIG. 1 shows schematically an embodiment of the device; and

FIG. 2 shows schematically a further embodiment of the device.

### DETAILED DESCRIPTION OF EXEMPLARY EMBODIMENTS

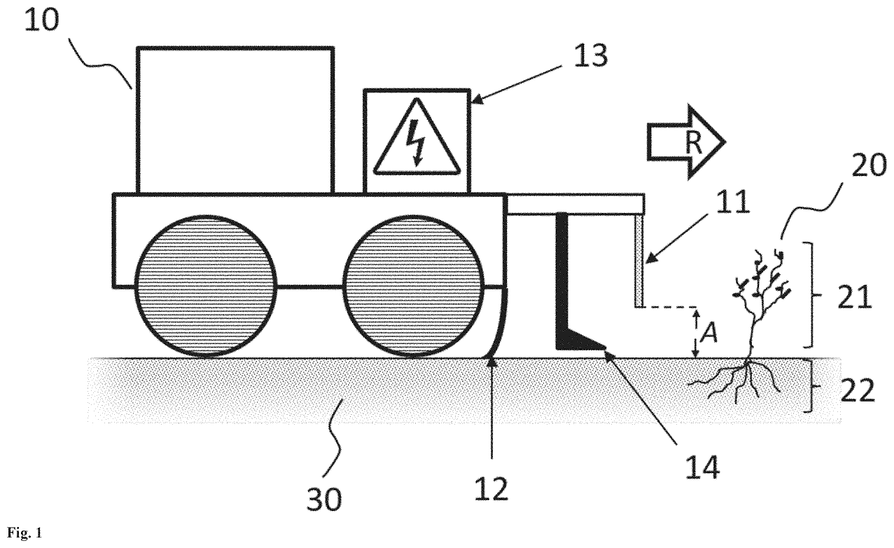

FIG. 1 shows schematically an embodiment of the device according to the invention. The device is implemented as a vehicle (10). The vehicle (10) moves in the movement direction (R) towards a plant (20) that is growing in the ground (30). In the frontal region of the vehicle (10) a contact electrode (11) is attached at a defined vertical distance A above the ground (30). A collecting electrode (12) is in contact with the ground (30). An electrical voltage can be applied between the contact electrode (11) and the collecting electrode (12) by a voltage source (13). If the vehicle (10) moves in the movement direction (R) towards the plant (20) the contact electrode touches the plant (20). If there is a voltage between the contact electrode (11) and the collecting electrode (12) at the moment of this contact, an electrical current flows between the contact electrode (11) and the collecting electrode (12) through plant parts (21) above the ground (30), through plant parts (22) in the ground (30) and through parts of the ground (30). The plant (20) is weakened or destroyed by the current. A removal tool (14) is located, in the sense of the movement direction (R) of the vehicle, behind the contact electrode (11). If the vehicle moves further in the movement direction (R), the plant (20) comes into contact with the removal tool (14). The plant parts (21) above the ground (30) are removed by the removal tool (14). The plant parts (22) in the ground (30) can remain in the ground (30).

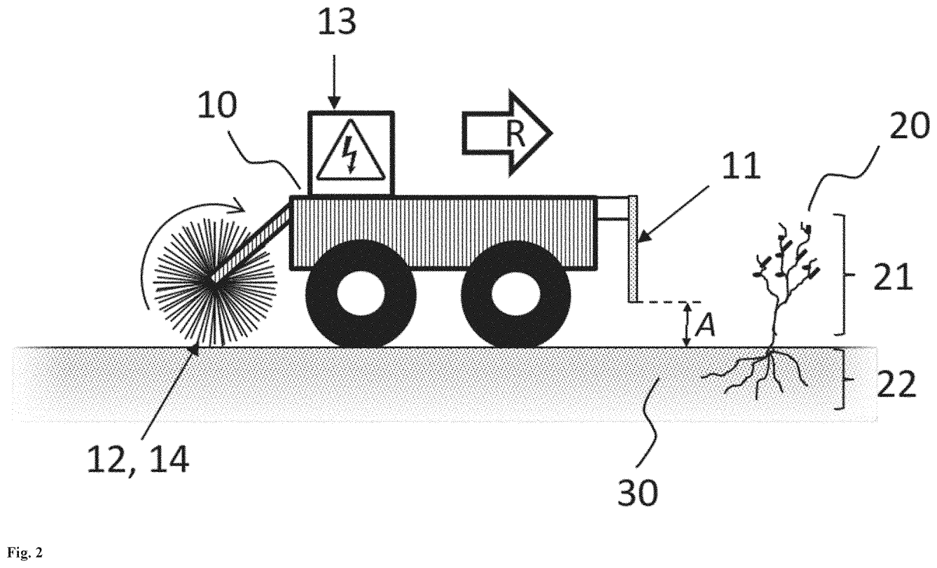

FIG. 2 shows schematically a further embodiment of the device according to the invention. The device is implemented as a vehicle (10). The vehicle (10) moves in the movement direction (R) towards a plant (20) that is growing in the ground (30). A contact electrode (11) is attached in the frontal region of the vehicle (10) having a defined vertical distance A above the ground. A rotating wire brush is attached in the rear region of the vehicle (10), and functions simultaneously as the collecting electrode (12) and as the removal tool (14). The rotating wire brush is in contact with the ground (30). An electrical voltage is applied between the contact electrode (11) and the wire brush by a voltage source (13). If the vehicle (10) moves towards the plant (20) in the movement direction (R), the plant (20) comes into contact with the contact electrode (11). On contact, an electrical current flows between the contact electrode (11) and the wire brush, flowing through plant parts (21) above the ground (30), through plant parts (22) in the ground (30), and through a part of the ground (30). As the device moves further in the movement direction (R), the plant (20) comes into contact with the rotating wire brush, and is captured and torn apart by it.

1. A device comprising
a collecting electrode, wherein the collecting electrode is configured to be brought into contact with the ground,
a contact electrode, wherein the contact electrode is configured to be brought to a defined height above the ground, wherein the contact electrode is attached to the device in a frontal region of the device,
a voltage source for the application of a voltage between the contact electrode and the collecting electrode and
a removal tool that is located behind the contact electrode,
wherein the device is configured to be moved over the ground, and when the device moves in such a way the contact electrode comes into contact with plants that are growing in the ground, wherein when such contact occurs an electrical current flows between the contact electrode and the collecting electrode through parts of the plants, and the parts of the plants that are located above the ground are removed by the removal tool after the flow of current.

2. The device of claim 1, wherein the removal tool is a cutting tool that is configured to separate plant parts above the ground from plant parts in the ground.

3. The device of claim 1, wherein the removal tool is implemented as a blade or an arrangement of blades.

4. The device of claim 1, wherein the removal tool functions simultaneously as the collecting electrode.

5. The device of claim 1, wherein the collecting electrode is implemented as a sliding contact, plough or wheel.

6. The device of claim 1, wherein the removal tool is implemented as a rotating wire brush.

7. The device of claim 1, further comprising a collecting container to accommodate separated plant parts.

8. The device claim 7, further comprising a collector tool for conveying separated plant parts into the collecting container.

9. The device of claim 1, comprising one or a plurality of distance sensors for ascertaining
a vertical distance of the contact electrode above the ground,
a vertical distance of the removal tool above the ground,
a vertical distance of the collecting electrode above the ground and/or
a horizontal distance of the contact electrode from the collecting electrode.

10. The device of claim 1, comprising one or a plurality of plant sensors for ascertaining a growth height of the plants and/or one or a plurality of contact sensors for ascertaining a contact of the contact electrode with a plant.

11. The device of claim 1, comprising a control unit that is configured to adjust a vertical distance between the contact electrode and the ground, a vertical distance between the removal tool and the ground, a vertical distance of the collecting electrode from the ground, and/or a horizontal distance between the collecting electrode and the contact electrode to a defined value and/or to hold them at a defined value during a movement of the device over the ground.

12. A method comprising:
providing a device comprising
a collecting electrode, wherein the collecting electrode is implemented in such a way that it is in contact with a ground,
a contact electrode, wherein the contact electrode is implemented in such a way that it is located at a defined height above the ground,
a voltage source with which a voltage is applied between the contact electrode and the collecting electrode, and
a removal tool,
moving the device over the ground in a direction of an unwanted plant, wherein the contact electrode is located, in the sense of the movement direction, in front of the removal tool, and thereby:
bringing the unwanted plant in the ground into contact with the contact electrode, wherein an electrical current flows between the contact electrode and the collecting electrode through the plant,
following the flow of current: removing parts of the plant that are located above the ground with the removal tool.

13. The method of claim 12, removing parts of the plant that are located above the ground with the removal tool comprises:
separating the parts of the plant that are located above the ground from parts of the plant that are located in the ground, and
conveying the separated parts into a collecting container.

14. The method of claim 12, wherein the removal tool functions simultaneously as the collecting electrode.

15. The method of claim 12, further comprising:
identifying an unwanted plant before moving the device over the ground in the direction of the unwanted plant and/or
ascertaining a growth height of the unwanted plant and
setting a defined vertical distance of the contact electrode above the ground and/or
setting a defined vertical distance of the removal tool above the ground and/or
setting a defined horizontal distance of the contact electrode from the collecting electrode and/or
setting a level of the voltage between the contact electrode and the collecting electrode and/or
setting a frequency of an alternating voltage between the contact electrode and the collecting electrode
setting a speed of the device over the ground
depending on the ascertained growth height and/or depending on the identified plant and/or
ascertaining a contact of the contact electrode with the unwanted plant, and applying the voltage between the contact electrode and the collecting electrode on contact of the contact electrode with the unwanted plant.
